(19) United States
(12) Patent Application Publication
(10) Pub. No.: US 2020/0224343 A1
(43) Pub. Date: Jul. 16, 2020

(54) UNDERGARMENT AND METHOD FOR MANUFACTURING THE UNDERGARMENT

(71) Applicant: MACKENT FABRICS CO., LTD., TAOYUAN CITY (TW)

(72) Inventor: Tai-Li HSIAO, TAOYUAN CITY (TW)

(21) Appl. No.: 16/829,823

(22) Filed: Mar. 25, 2020

Related U.S. Application Data
(62) Division of application No. 14/723,111, filed on May 27, 2015.
Application No. 14/723,111 is a continuation-in-part of application No. 14/199,253, filed on Mar. 6, 2014, now abandoned.

(30) Foreign Application Priority Data
Aug. 28, 2013 (TW) 102216195

(51) Int. Cl. D04B 21/16; B32B 5/02; B32B 5/26; D04B 21/20; D04B 21/08; B32B 3/28

(52) U.S. Cl. CPC D04B 21/16; B32B 2262/0292; B32B 5/26; D04B 21/207; D04B 21/08; B32B 3/28; B32B 2250/03; B32B 2250/20; B32B 2307/724; B32B 2307/726; B32B 2437/00; D10B 2501/02; D10B 2331/04; D10B 2331/10; B32B 2307/718; B32B 2262/0284; B32B 5/026

(57) ABSTRACT

A fabric structure is provided. The fabric structure includes an upper fabric layer knitted with a plurality of first PET (polyethylene terephthalate) fibers and a plurality of first PU (polyurethane) fibers; a lower fabric layer 100% knitted with a plurality of second PU fibers; and a central fabric layer interposed between said upper fabric layer and said lower fabric layer, knitted with a plurality of wave-like second PET fibers, wherein crests of the wave-like second PET fibers are intertwined with the upper fabric layer, and wherein troughs of the wave-like second PET fibers are intertwined with the lower fabric layer. The fabric structure features superior stretchability, superior resilience, mild stickiness, and slip-proofness.

This is a divisional application of application Ser. No. 14/723,111, filed on May 27, 2015, which is a continuation-in-part of application Ser. No. 14/199,253, filed on Mar. 6, 2014, and which claims priority of Application No. 102216195 filed in Taiwan on Aug. 28, 2013 under 35 U.S.C. 119. The entire contents of all of which are hereby incorporated by reference.

### BACKGROUND OF THE INVENTION

### Technical Field

The present invention relates to an improved fabric structure and, more particularly, to a novel fabric structure which enables a garment or undergarment made thereof to be highly supportive and can lie in close contact with the wearer's skin.

### Description of Related Art

Consumer's requirements and market's demand for the fabric structure of clothes are increasing. The fabric structure as expected should be breathable, effective in heat dissipation, sweat-absorbent, comfortable, and lightweight. Consequently, a variety of weaving methods, fiber materials, and fiber arrangements for the fabric structure of garments were developed.

Take brassieres as an example. It is generally required that a bra provides enough support for the breasts and also won't slip easily. When it comes to bras without shoulder straps, the requirement is much higher for such a bra that should be in close contact with the wearer's skin and must stay where it is supposed to be without slipping; otherwise, the wearer is subject to the embarrassment of having the bra shifted away from its desired position.

However, the fabric structure of the commercially available fabrics (also known as spacer fabrics or sandwich fabrics) fails to meet the aforesaid requirements for the undergarment, such as the bra. Therefore, there is a need for the improved bra with the improved fabric structure to meet the consumer's requirements and the market demands.

### BRIEF SUMMARY OF THE INVENTION

To solve the foregoing problems, one object of this invention is to provide a bra with a fabric structure, wherein the lower fabric layer is knitted with the elastic PU (polyurethane) fibers. It thus features superior stretchability, superior resilience, mild stickiness, and slip-proofness.

The present invention provides an improved bra with a fabric structure in which the fabric structure includes an upper fabric layer, a middle fabric layer, and a lower fabric layer sequentially stacked together. The middle fabric layer has a corrugated shape, and one of the upper and lower fabric layers is composed of 100% elastic fibers.

Accordingly, one embodiment of the present invention provides a bra with a fabric structure including an upper fabric layer knitted with a plurality of first PET (polyethylene terephthalate) fibers and a plurality of first PU (polyurethane) fibers; a lower fabric layer 100% knitted with a plurality of second PU fibers; and a central fabric layer interposed between the upper fabric layer and the lower fabric layer, knitted with a plurality of wave-like second PET fibers, wherein crests of the wave-like second PET fibers are intertwined with the upper fabric layer, and wherein troughs of the wave-like second PET fibers are intertwined with the lower fabric layer.

Another embodiment of the present invention provides a bra with a fabric structure including an upper fabric layer, a lower fabric layer and a central fabric layer. The upper fabric layer is knitted with a plurality of first PET fibers and a plurality of first PU fibers. The lower fabric layer is knitted with a plurality of second PU fibers and a plurality of third PET fibers, wherein the second PU fibers are knitted into a plurality of first regions, the third PET fibers are knitted into a plurality of second regions, and the first regions and the second regions are arranged alternately and intertwined together. The central fabric layer interposed between the upper fabric layer and the lower fabric layer, is knitted with a plurality of wave-like second PET fibers, wherein crests of the wave-like second PET fibers are intertwined with the upper fabric layer, and troughs of the wave-like second PET fibers are intertwined with the lower fabric layer.

As one of the upper and lower fabric layers of the fabric structure is composed of 100% elastic fibers, the properties of the elastic fibers such as stretchability, elastic recovery, softness, and a slight degree of adhesiveness can render a garment made of the fabric structure highly supportive and capable of lying in close contact with the wearer's skin.

### BRIEF DESCRIPTION OF THE DRAWINGS

The structure and advantages of the present invention is best understood by referring to the following detailed description of an illustrative embodiment in conjunction with the accompanying drawings, in which:

FIG. 1 is a perspective view of a preferred embodiment of the present invention;

FIG. 2 is a diagram schematically showing the present invention with the fabric structure;

FIG. 3 is a diagram schematically showing the fabric structure in the present invention;

FIG. 4 is an exploded view schematically showing the fabric structure according to one embodiment of the present invention;

FIG. 5 is a perspective view schematically showing a fabric structure according to one embodiment of the present invention;

FIG. 6 is a diagram schematically showing a lower fabric layer of a fabric structure according to one embodiment of the present invention; and

FIG. 7 is a diagram schematically showing an upper fabric layer of a fabric structure according to one embodiment of the present invention.

### DETAILED DESCRIPTION OF THE INVENTION

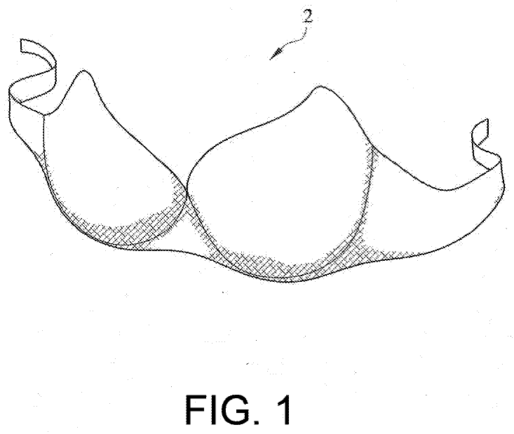

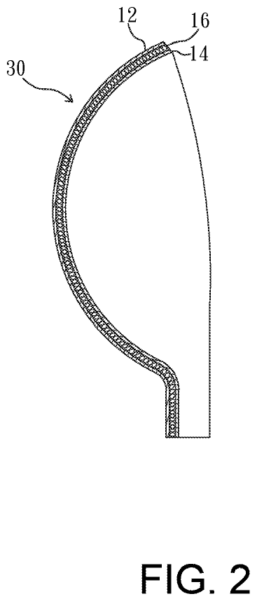

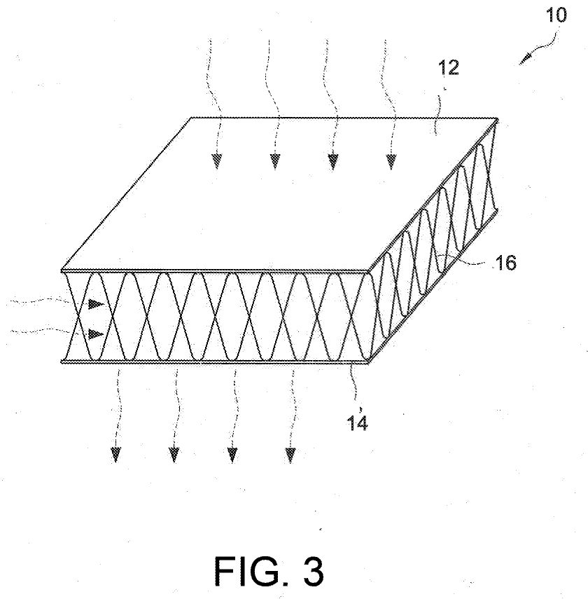

FIGS. 1 and 2 are schematic drawings showing an application of the preferred embodiment of the present invention. More specifically, the bra 2 in FIGS. 1 and 2 is formed of the fabric structure 10 shown in FIGS. 3-7.

The bar 2 in FIG. 1 has a pair of bra cups, each bra cup in the pair having an inner edge and an outer edge, the inner edges configured to be coupled to one another. The bar 2 further has a pair of bra wings, each bra wing in the pair having a first end and a second end, each first end being coupled to the outer edge of each bra cup, respectively, and the second end configured to be coupled to one another. Further, at least one of the pair of bra cups and the pair of bra wings comprises a layer of fabric having intrinsically sticky fibers.

FIG. 2 shows a cross-section view of the bra cup 30 of the bra 2 in FIG. 1. The bra cup comprises a layer of fabric having intrinsically sticky fibers forming an inner layer of the bra as to cause the bra to cling to the wearer's skin. In one embodiment, the bra cup comprises a lower layer 14, a middle layer 16, and an upper layer 12. The lower layer 14 is an inner layer that contacts wearer's skin while the bra is being worn; and the lower layer 14 is a sticky fiber.

The fabric structure of the present invention may be for the cloth in general as well as the bra. As shown in FIG. 2, while a woman wears the bra cup 30 of the present invention made of the fabric structure as disclosed embodiment, the ripple-like central fabric layer 16 has a superior moisture permeation effect and a superior air permeation (heat dissipation) effect. The lower fabric layer 14, which is knitted with the PU fibers and features stretchability and mild stickiness, can support the breast very well. Further, the mild stickiness makes the bra contact the skin intimately and unlikely to slip. Therefore, the fabric structure of the present invention can enhance the supportability of the bra and make the bra contact the skin intimately.

When the bra 2 is worn, the corrugated middle fabric layer 16 provides good permeability whereby moisture and air (heat) can pass through the bra 2, as indicated by the arrows in FIG. 3.

Moreover, with the lower fabric layer 14 being composed of 100% elastic fibers and in contact with the wearer's skin, the properties of the elastic fibers such as stretchability, elastic recovery, softness, and a small degree of adhesiveness enable the bra 2 formed of the fabric structure 10 to provide sufficient support for the breasts. The slight adhesiveness also allows the bra 2 to attach to the skin without slipping. Thus, the bra 2 is highly supportive and can lie in close contact with the wearer's skin.

Please refer to FIG. 3 for a perspective view of the fabric structure for a preferred embodiment of the present invention. As shown in FIG. 3, the fabric structure 1 includes an upper fabric layer 12, a middle fabric layer 16, and a lower fabric layer 14 sequentially stacked together. In other words, the fabric structure 1 includes three fabric layers arranged in a three-dimensional manner and is, therefore, so-called spacer fabrics or sandwich fabrics.

As shown in FIG. 3, the middle fabric layer 16 is of a corrugated shape. Besides, one of the upper fabric layer 12 and the lower fabric layer 14 is composed of 100% elastic fibers. In this embodiment, the lower fabric layer 14 is composed of 100% elastic fibers. It is understood, however, that the upper fabric layer 12 instead may be composed of 100% elastic fibers.

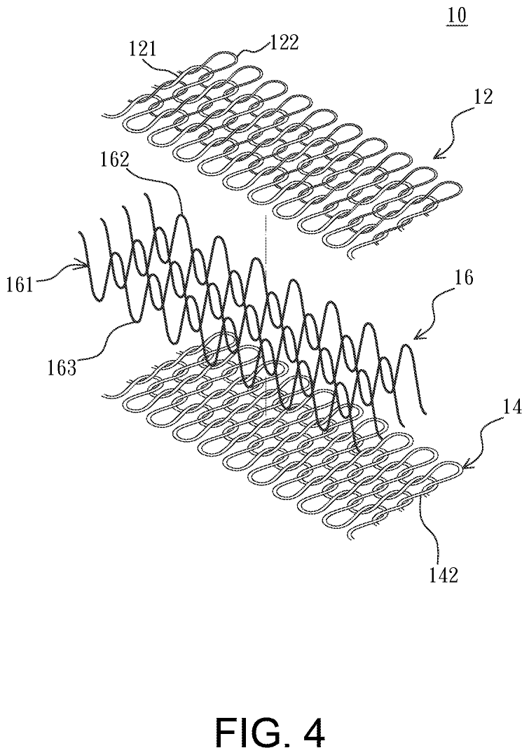

Refer to FIG. 4, an exploded view schematically showing a fabric structure according to one embodiment of the present invention. The fabric structure 10 of the present invention includes an upper fabric layer 12, a lower fabric layer 14, and a central fabric layer 16. A plurality of first PET (polyethylene terephthalate) fibers 121 and a plurality of first PU (polyurethane) fibers 122 are knitted into the upper fabric layer 12. A plurality of second PU fibers 142 are knitted into the lower fabric layer 14. The central fabric layer 16 is interposed between the upper fabric layer 12 and the lower fabric layer 14. The central fabric layer 16 consists of a plurality of wave-like second PET fibers 161. The crests 162 of the wave-like second PET fibers 161 are intertwined with the upper fabric layer 12. The troughs 163 of the wave-like second PET fibers 161 are intertwined with the lower fabric layer 14.

In one embodiment, the upper fabric layer 12 and the lower fabric layer 14 are knitted in a circular knitting method or a warp knitting method. Because of the characteristics of PU material, the lower fabric layer 14, which is 100% knitted with the second PU fibers 142, has stretchability and mild stickiness.

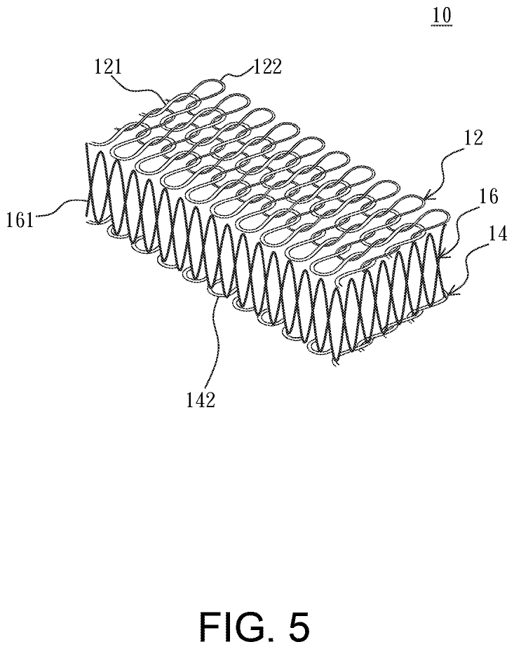

As shown in FIG. 4, the lower fabric layer 14 comprises a plurality of loop-textures. Referring to FIG. 5, a perspective view schematically showing a fabric structure according to one embodiment of the present invention, the fabric structure 10 includes three fabric layers: the upper fabric layer 12, the lower fabric layer 14, and the central fabric layer 16. In the embodiment, the central fabric layer 16 is a spacer fabric or a sandwich fabric knitted in a 3D knitting method and has a ripple-like appearance. The second PET fiberS 161, which is used to knit the central fabric layer 16, can be monofilament fibers or multifilament fibers.

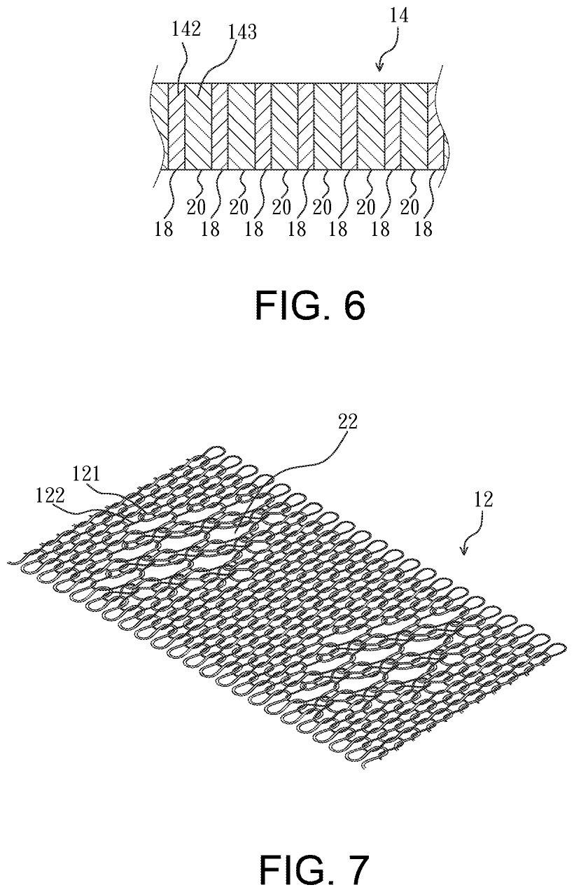

In the previous embodiment, the lower fabric layer 14 is 100% knitted with the second PU fibers 142. In another embodiment, the lower fabric layer 14 may be knitted with the second PU fibers 142 plus a plurality of third PET fibers 143. Referring to FIG. 6, a diagram schematically showing a lower fabric layer of a fabric structure according to one embodiment of the present invention.

In the embodiment shown in FIG. 6, the lower fabric layer 14 is knitted with a plurality of second PU fibers 142 and a plurality of third PET fibers 143, wherein the second PU fibers 142 are knitted into a plurality of first regions 18, and wherein the third PET fibers 143 are knitted into a plurality of second regions 20. In one embodiment, the first regions 18 and the second regions 20 are in the form of strips arranged alternately and intertwined together. The width of the first region 18 is identical to or different from the width of the second region 20. The first region 18 and the second region 20, which are respectively knitted with different materials, have different thicknesses. The lower fabric layer 14 features the cotton tactility of PET fibers and the stretchability and mild stickiness of PU fibers. The present invention does not limit that the second PU fibers 142 and the third PET fibers 143 must be knitted into strips. In the present invention, the second PU fibers 142 and the third PET fibers 143 may be knitted into another shape according to the fabric design.

Referring to FIG. 7, a diagram schematically showing an upper fabric layer of a fabric structure according to one embodiment of the present invention. In one embodiment, the upper fabric layer 12 is knitted to have Jacquard patterns 22 to promote the esthetic effect. As shown in FIG. 7, a portion of the first PET fibers 121 and/or a portion of the first PU fibers 122 are knitted to form at least one Jacquard pattern 22 on the upper fabric layer 12.

In the present invention, the upper fabric layers, central fabric layers, and lower fabric layer of the fabric structure are all fabricated in knitting methods. The lower fabric layer is 100% knitted with the stretchable PU fibers and thus features superior stretchability, superior resilience, mild stickiness, and slip-proofness.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A bra, comprising:
a pair of bra cups, each bra cup in the pair having an inner edge and an outer edge, the inner edges configured to be coupled to one another; and
a pair of bra wings, each bra wing in the pair having a first end and a second end, each first end being coupled to the outer edge of each bra cup, respectively, and the second end configured to be coupled to one another;
wherein at least one of the pair of bra cups and the pair of bra wings comprises a layer of fabric having intrinsically sticky fibers; and
wherein the layer of fabric having intrinsically sticky fibers comprises an inner layer of the at least one of the pair of bra cups and contacts a wearer's skin while the bra is being worn, so as to cause the bra to cling to the wearer's skin.

2. The bra of claim 1, wherein the intrinsically sticky fibers comprise one or more of elastic fibers.

3. The bra of claim 2, wherein the bra comprises a knitted spacer fabric.

4. The bra of claim 3, wherein the knitted spacer fabric comprises an inner face knitted of spandex for contacting the wearer's skin.

5. The bra of claim 2, wherein the bra comprises a three-layer fabric.

6. The bra of claim 5, wherein the three-layer fabric comprises an inner face knitted of elastic fibers for contacting the wearer's skin.

7. A method of manufacturing a bra, the method comprising:
providing a first fabric having intrinsically sticky fibers;
providing a second fabric having intrinsically sticky fibers;
fashioning the first fabric having intrinsically sticky fibers into a pair of bra cups, each bra cup in the pair having an inner edge and an outer edge, and configuring the inner edges to be coupled to one another;
fashioning the second fabric having intrinsically sticky fibers into a pair of bra wings, each bra wing in the pair having a first end and a second end, coupling each first end to a respective one of the outer edges of the bra cups, and configuring the second ends to be coupled to one another; and
situating the pair of bra cups and the pair of bra wings such that the first fabric having intrinsically sticky fibers and the second fabric having intrinsically sticky fibers are both configured to contact a wearer's skin while the bra is being worn, so as to cause the bra to cling to the wearer's skin.

8. The method of claim 7, wherein the intrinsically sticky fibers comprise one or more of elastic fibers.

9. The method of claim 8, wherein the first fabric comprises a knitted spacer fabric.

10. The method of claim 9, wherein the knitted spacer fabric comprises an inner face knitted of elastic fibers that are configured to contact the wearer's skin.

11. The method of claim 8, wherein the bra comprises a three-layer fabric.

12. The method of claim 11, wherein the three-layer fabric comprises an inner face knitted of elastic fibers that are configured to contact the wearer's skin.

13. A bra, comprising:
a pair of bra cups, each bra cup in the pair having an inner edge and an outer edge, the inner edges configured to be coupled to one another; and
a pair of bra wings, each bra wing in the pair having a first end and a second end, each first end being coupled to the outer edge of each bra cup, respectively, and the second end configured to be coupled to one another;
wherein the pair of bra cups comprises a layer of fabric having intrinsically sticky fibers; and
wherein the layer of fabric having intrinsically sticky fibers comprises an inner layer of the at least one of the pair of bra cups and contacts a wearer's skin while the bra is being worn, so as to cause the bra to cling to the wearer's skin.

14. A bra, comprising:
a pair of bra cups, each bra cup in the pair having an inner edge and an outer edge, the inner edges configured to be coupled to one another; and
a pair of bra wings, each bra wing in the pair having a first end and a second end, each first end being coupled to the outer edge of each bra cup, respectively, and the second end configured to be coupled to one another;
wherein at least one of the pair of bra cups and the pair of bra wings comprises a fabric structure, and the fabric structure comprises:
an upper fabric layer knitted with a plurality of first PET (polyethylene terephthalate) fibers and a plurality of first PU (polyurethane) fibers, wherein said plurality of first PET fibers and said plurality of first PU fibers are arranged alternately;
a lower fabric layer knitted with a plurality of 100% elastic fibers; and
a central fabric layer interposed between said upper fabric layer and said lower fabric layer, knitted with a plurality of wave-like second PET fibers, wherein crests of said wave-like second PET fibers are intertwined with said upper fabric layer, and wherein troughs of said wave-like second PET fibers are intertwined with said lower fabric layer;
wherein the plurality of 100% elastic fibers is formed of uniformly continuous weft-knitted loops such that the lower fabric layer features stretchability and stickiness; and
wherein the fabric structure is fabricated into the bra and said lower fabric layer is in close contact with the skin of a wearer.
